(19) United States
(12) Patent Application Publication
(10) Pub. No.: US 2006/0245863 A1
(43) Pub. Date: Nov. 2, 2006

(54) Solid state detection system for measuring high levels in grain bins

(76) Inventor: Paul Wilcott, Moosomin (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/109,171

(22) Filed: Apr. 19, 2005

(51) Int. Cl. B65G 1/00

(52) U.S. Cl. 414/296

(57) ABSTRACT

A bin fill indicator for determining when particulate matter filling a bin has reached a predetermined height is disclosed. The bin fill indicator comprises a sensor attachable beneath a spout on a discharge end of an auger and operative to generate a sensor signal in response to particulate matter flowing past the sensor and a monitor operatively connected to the sensor and operative to receive sensor signals and provide a notification when the monitor has not received a sensor signal within a predetermined period of time. When particulate matter is discharged out of the auger and into a bin, particulate matter flows past the sensor and the monitor receives sensor signals. When the sensor is buried under particulate matter in the bin, the sensor stops sending sensor signals to the monitor and the monitor notifies an operator of the auger.

This invention is in the field of bin level indicators and more specifically to bin level indicators that are attached to a particulate matter moving apparatus.

### BACKGROUND

When filling bins with grain, it is often hard to determine when the bin is full. Typically, a bin is filled using an auger or belt conveyor that moves grain fed into a bottom end of an auger at ground level up to the top of the auger and out a spout on the other end of the auger. The spout of the auger is placed over or in an opening to the bin at the top of the bin and grain fed into the bottom end of the auger will be moved up the auger to be discharged out the spout of the auger and into the bin through the bin opening. Because the top of the bin is usually much higher than the head of a person operating the auger, the operator cannot see the progress of the bin level as the auger is filling the bin with grain.

There are a number of prior art methods used for determining whether a bin has been filled with grain by an auger. The simplest and most time consuming is to get a ladder and periodically check on the progress of the bin as it is being filled. In addition to the time it takes to keep climbing up and down the ladder, this method also requires quite a bit of effort in that the operator must climb up and down the ladder and the storage bins can be quite high. Additionally, if checking is only done sporadically, the bin might be overflowed with grain between checking.

There are also a number of sensor systems available that are based on sensing the level in a bin, such as the device disclosed in Canadian Patent No. 2,273,307. When grain reaches a predetermined level in a bin, the person filling the bin is notified that the grain has reached the predetermined level and the person should stop filling the bin. Some of these devices work by sensing a light beam that is tripped when the grain covers up the source of the light beam. The device, disclosed by the Canadian Patent No. 2,273,307, operates by measuring the capacitance between two strips that are held apart. As the grain fills the bin, the strips are pushed together by the grain and by measuring the changes in the capacitance between the two strips, the height of grain in the bin can be determined.

One of the problems with these types of devices is that the sensing mechanism is attached to the bin and operates by sensing the grain within the storage bin. These devices are installed on the bins and are stationary in relation to the bin. A farmer will typically have a number of grain bins. To measure the level of grain in each of the bins, there must be one of these devices installed in each bin. This necessitates the purchasing of a number of devices in order to measure the height in each of the bins.

Another type of device used to measure the level of grain in a grain bin is a tilt-type switch. These tilt-type level sensors have a tilting mechanism that triggers a signal when the grain reaches a certain level in the bin. In the case of tilt switches, the tilt switch will trigger a signal when the grain reaches the tilt switch and pushes it up. These tilt switches, such as the device disclosed in Canadian Pat. No. 2,274,191, can be moved from bin to bin. However, the tilt switches contain moving parts that must be functional to operate. In environments containing small particles and dust, such as grain bins, these moving parts can often jam with dust and particles and prevent these devices that rely on moving parts from operating properly.

Another problem with these types of level sensors is that an alarm state is triggered only when a certain event occurs, i.e. the grain triggers a light beam on the sensor or flips a switch. If there is a problem with these types of level sensors, the level sensors will usually appear to be acting properly until it is too late and the bin has been overflowed. This is because these level sensors only send a signal when the grain in the bin reaches a predetermined level. They do not provide any signals while the auger is filling the bin with grain. For example, if a wire is cut in the system or a sensor is malfunctioning so that it will never send a signal, no signal is expected from the device while the bin is being filled with grain, so even though the level sensor is malfunctioning the level sensor will appear, in its malfunctioning state, to be acting exactly as it would if it was working properly because under normal circumstances the level sensor will not provide a signal while the grain is filling the bin. It is only when the grain reaches the predetermined level in the bin that the level sensor will fail to operate as it would under normal circumstances and fail to generate a signal that the bin is filled. The operator will not be notified during the operation of the auger that the level sensor is not operating properly and it may not be apparent to an operator of an auger that the level sensor is malfunctioning until after the bin had been overfilled.

### SUMMARY OF THE INVENTION

It is an object of the present invention to overcome disadvantages in the prior art.

The present invention provides, in a first embodiment, a bin fill indicator apparatus for determining when particulate matter filling a bin has reached a predetermined height. The apparatus comprises: a sensor attachable beneath a spout on a discharge end of an auger and operative to generate sensor signals in response to particulate matter flowing past the sensor; and a monitor operatively connected to the sensor and operative to receive sensor signals and operative to provide a notification when the monitor has not received a sensor signal within a predetermined period of time.

The present invention provides, in a second embodiment, an auger operative to determine when a bin being filled with particulate matter by the auger has reached a predetermined height in the bin. The auger comprising: a bottom end operative to receive particulate matter; a discharge end having a spout wherein particulate matter fed into the bottom end is moved by the auger from the bottom end to the discharge end, where it is discharged from the auger through the spout; a sensor attached beneath the spout and operative to generate a sensor signal in response to particulate matter flowing past the sensor; and a monitor operatively connected to the sensor and operative to receive sensor signals and operative to provide a notification when the monitor has not received a sensor signal from the sensor within a predetermined period of time.

The present invention provides, in a third embodiment, a method of detecting when particulate matter has reached a predetermined height in a bin. The method comprises: positioning a sensor beneath a spout on a discharge end of an auger, the sensor operative to generate a signal when particulate matter impacts the sensor; positioning the spout over a fill opening of the bin; using the auger to fill the bin with particulate matter; monitoring the signals generated by the sensor as the particulate matter impacts the sensor; activating an alarm when a predetermined time has passed and no signals have been generated by the sensor; and stopping using the auger to fill the bin with particulate matter.

In operation, as particulate matter is discharged out of the spout of the auger and into a bin, the particulate matter flows past a sensor positioned beneath the spout of the auger. When this particulate matter flows past the sensor, the sensor generates sensor signals in response to this flow and the monitor receives these sensor signals transmitted by the sensor. As particulate matter continues to be discharged out of the spout of the auger, this particulate matter continues to flow past the sensor and the sensor continues to generate sensor signals in response to the particulate matter flow. The monitor receives these sensor signals from the sensor. As the particulate matter fills the bin to the point where the sensor is covered by the particulate matter, particulate matter being discharged out of the spout of the auger no longer flows past the sensor and the sensor stops generating sensor signals. The monitor, no longer receiving sensor signals from the sensor, notifies the operator that the sensor is no longer sensing a flow of particulate matter past the sensor and the operator should stop the auger before the bin is overflowed with particulate matter.

In one variation of the present invention, the sensor is an impact-type flow sensor. The sensor is operative to generate sensor signals in response to particulate matter flowing past the sensor by placing the sensor in the flow of the particulate matter wherein the sensor is operative to detect the impact of particulate matter against the sensor. As the sensor is impacted by particulate matter, the sensor generates sensor signals in response to the impacts.

Because the bin fill indicator apparatus is attached to the auger, it can be used on any number of bins, and conveniently moves with the auger. When a first bin is filled with particulate matter, an operator can move the auger to a second bin. Because the bin fill indicator apparatus is attached to the auger, a single bin fill indicator apparatus can be used when filling any number of bins with the auger.

In an embodiment of the bin fill indicator apparatus, the sensor is operative to transmit a constant voltage to the monitor when the sensor is not being impacted and a different voltage is used as the sensor signal. In this manner, if the bin fill indicator apparatus is turned on and there is a problem with the circuit between the monitor and the sensor, the monitor does not receive the expected constant voltage from the sensor and the monitor provides an error notification to an operator of the auger. In this manner, the present invention can notify an operator that the bin fill indicator apparatus is not functioning properly before the operator overfills the bin and finds out for him or herself.

In another embodiment of the invention, a bin fill indicator apparatus comprises a first sensor and a second sensor wherein the first sensor is positioned beneath a spout on a discharge end of an auger and the second sensor is positioned below the first sensor. The first sensor is operative to generate a first sensor signal in response to the flow of particulate matter past the first sensor and the second sensor is operative to generate a second sensor signal when particulate matter flows past the second sensor. In this manner, when the bin fill indicator apparatus is installed on an auger and in operation, particulate matter filling a bin will cover the second sensor before it covers the first sensor. The monitor, not receiving second sensor signals from the second sensor, provides a warning notification to an operator, so that the operator knows that the bin is getting close to being filled with the particulate matter and the operator can make any necessary changes, such as stopping feeding particulate matter into the auger or slowing down the auger. Once the particulate matter also covers the first sensor, the monitor, not having received first sensor signals from the first sensor for a predetermined period of time, provides a full notification and the operator knows that the bin is filled to a level above the first sensor. It is contemplated to be within the scope of the present invention that rather than using only a first and second sensor any number of additional sensors could be used with the bin fill indicator apparatus.

While the invention is claimed in the concluding portions hereof, preferred embodiments are provided in the accompanying detailed description which may be best understood in conjunction with the accompanying diagrams where like parts in each of the several diagrams are labeled with like numbers, and where:

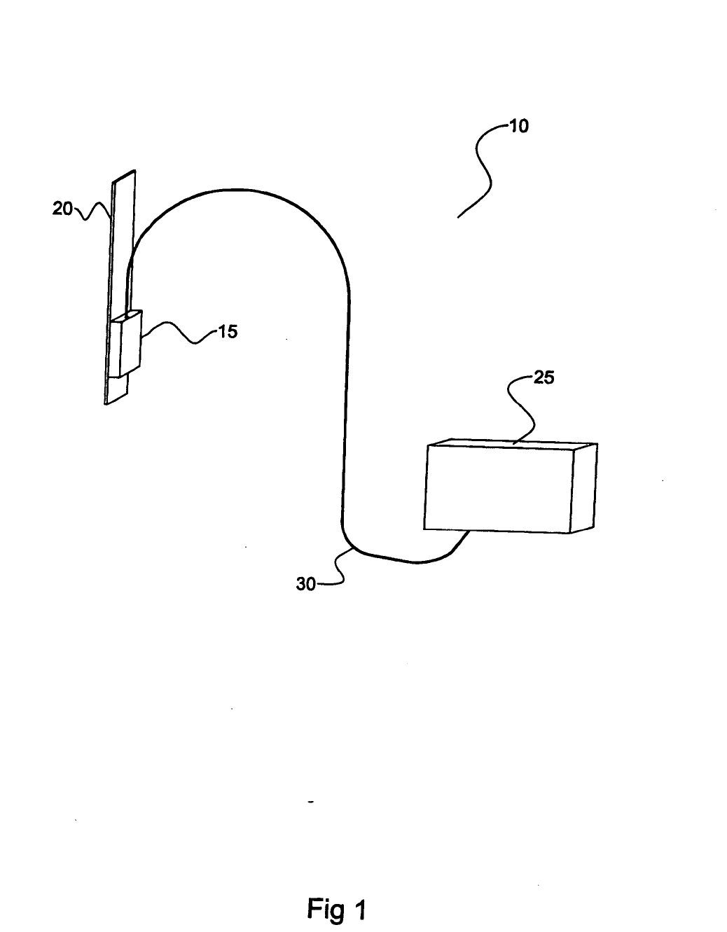

FIG. 1 is a perspective view of an embodiment of a bin fill indicator apparatus in accordance with the present invention;

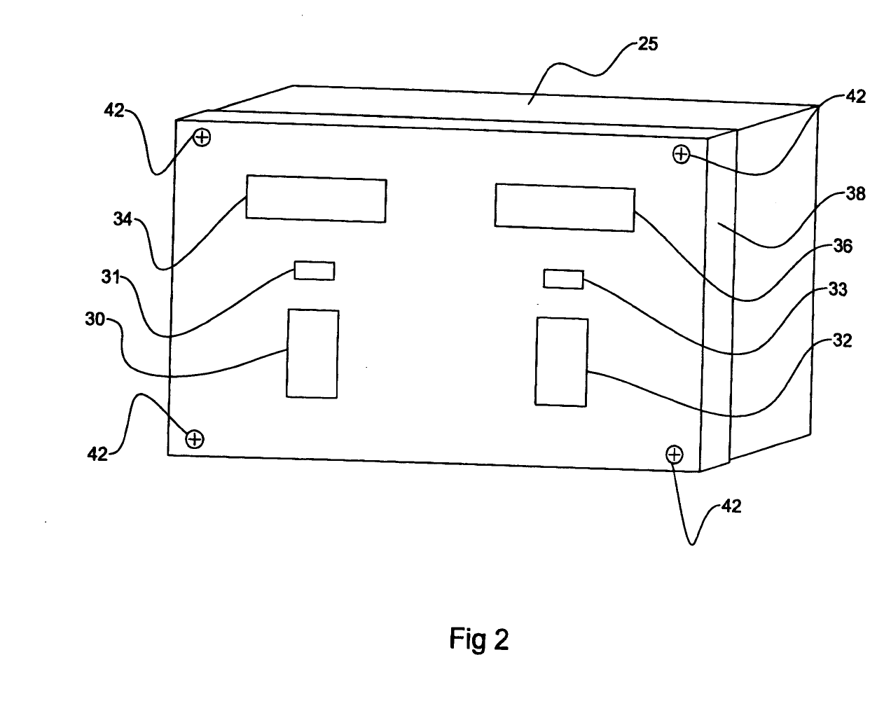

FIG. 2 is a perspective view of a monitor of the bin fill indicator apparatus of FIG. 1;

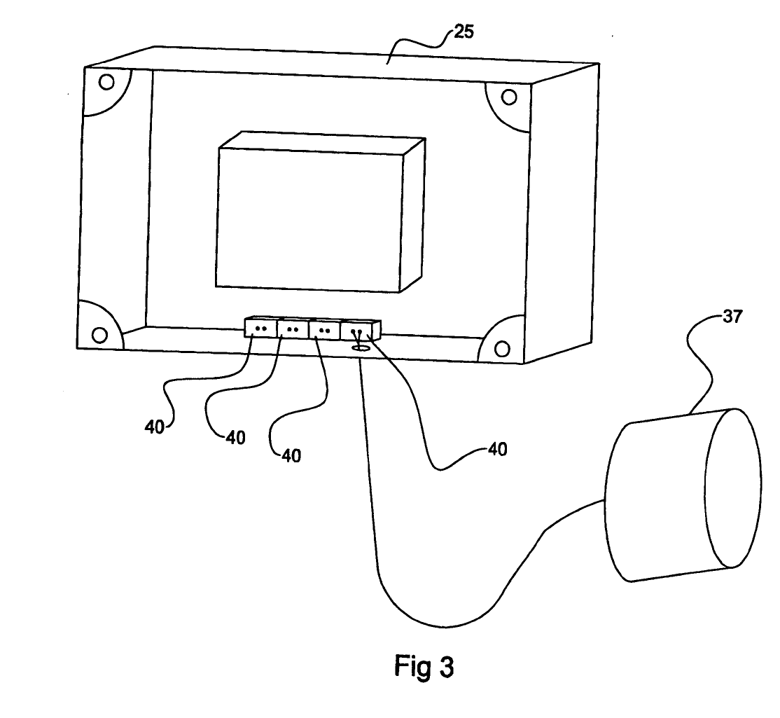

FIG. 3 is a perspective view of the monitor of FIG. 2, with a removable lid removed;

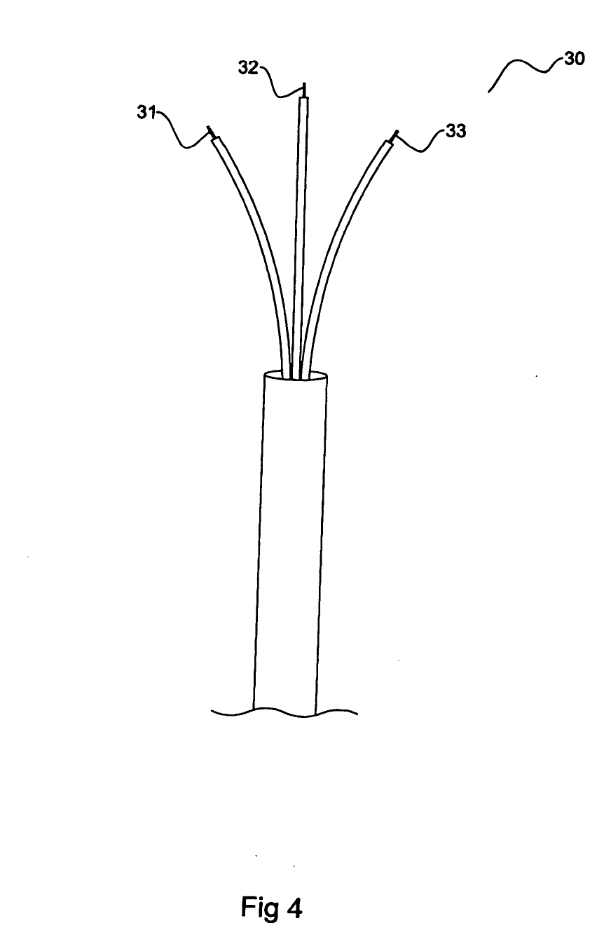

FIG. 4 illustrates the wires comprising the connecting wires of the bin fill indicator apparatus of FIG. 1;

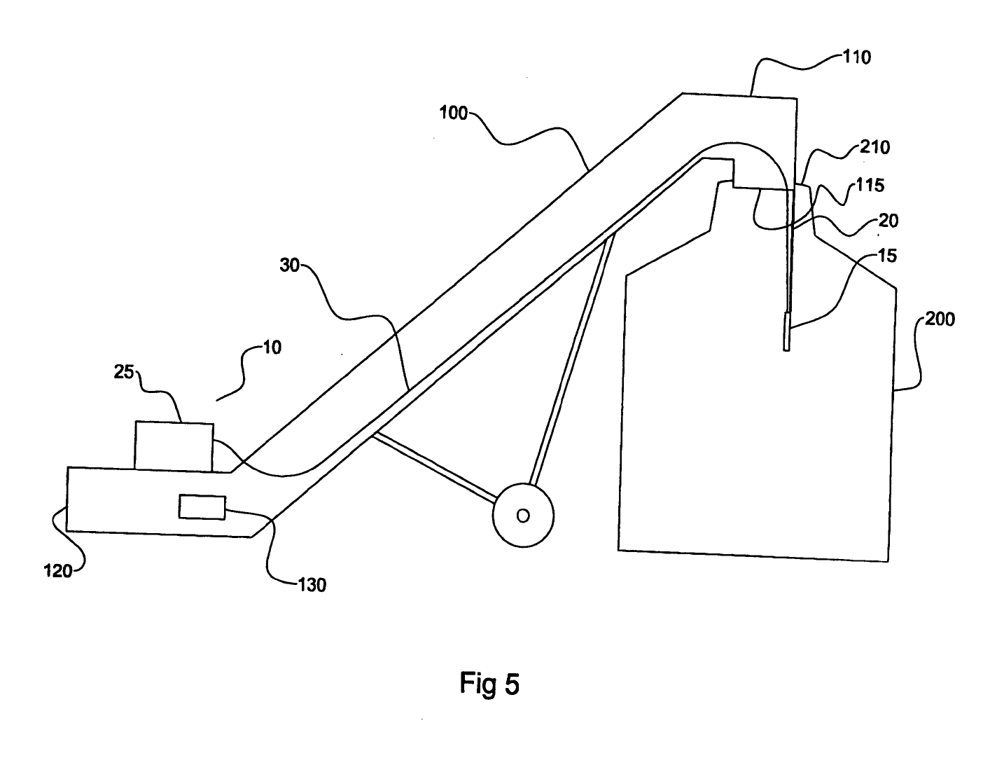

FIG. 5 is a side view of the bin fill indicator apparatus of FIG. 1 installed on an auger positioned to fill a bin;

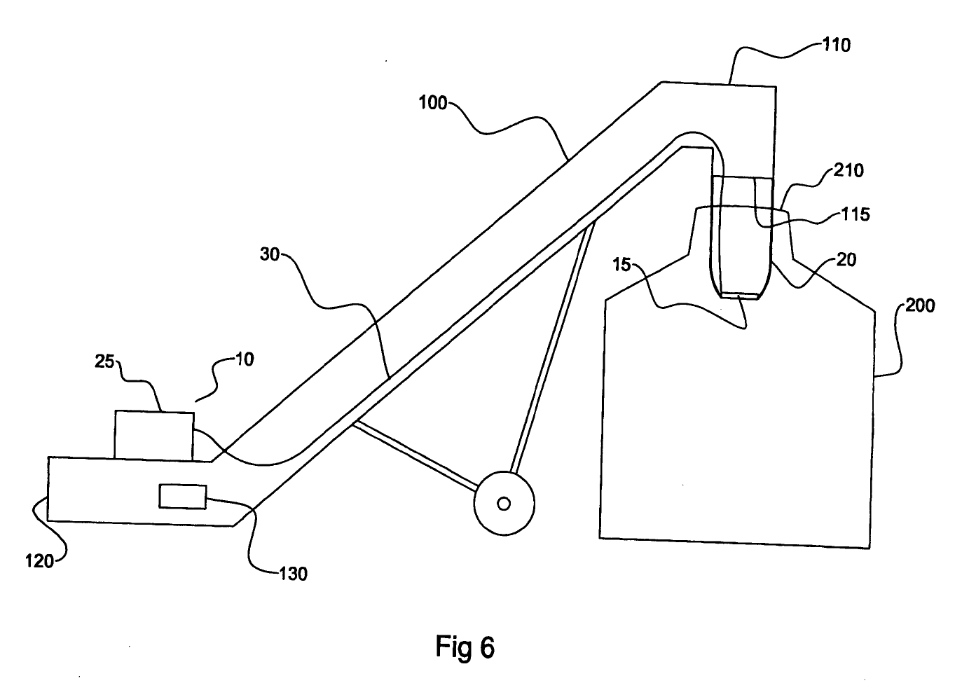

FIG. 6 is a side view of the bin fill indicator apparatus of FIG. 1 installed on an auger positioned to fill a bin, in an alternate mounting configuration;

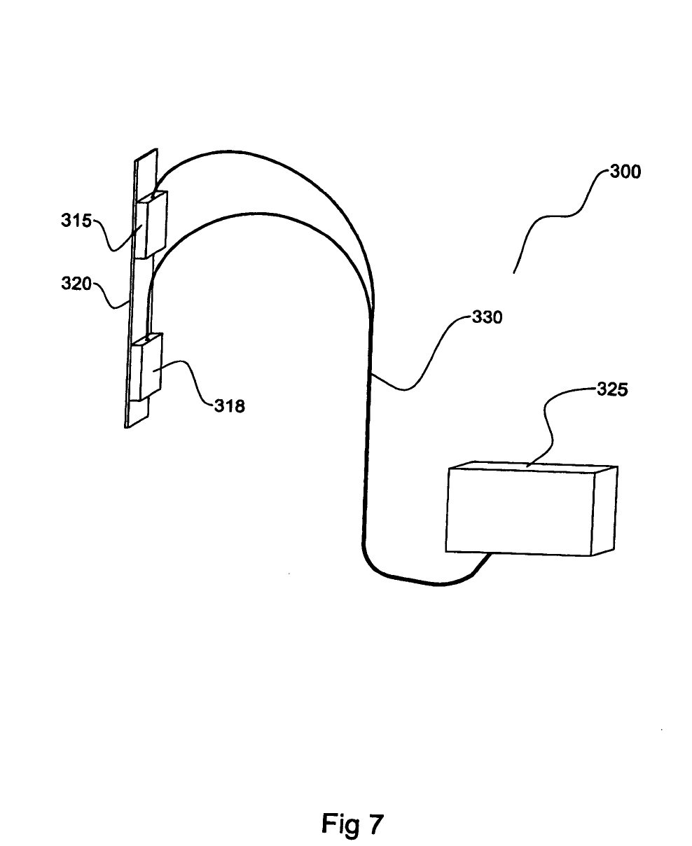

FIG. 7 is perspective view of an alternate embodiment of a bin fill indicator apparatus comprising a second sensor;

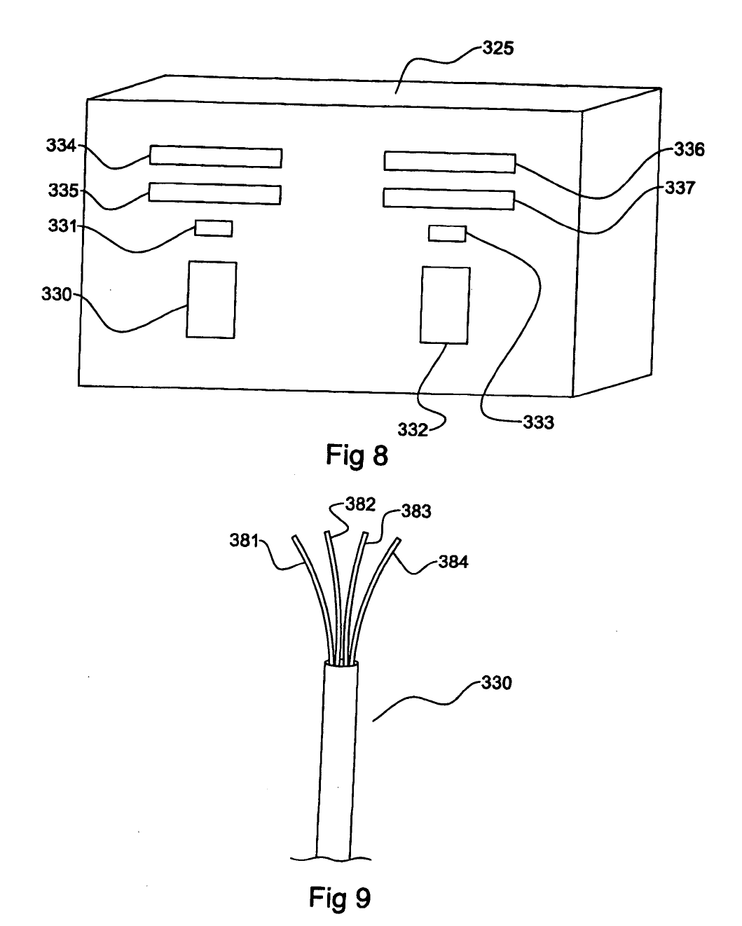

FIG. 8 is a perspective view of the monitor of the bin fill indicator apparatus of FIG. 7;

FIG. 9 illustrates the wires of the connecting wires of the bin fill indicator apparatus of FIG. 7; and

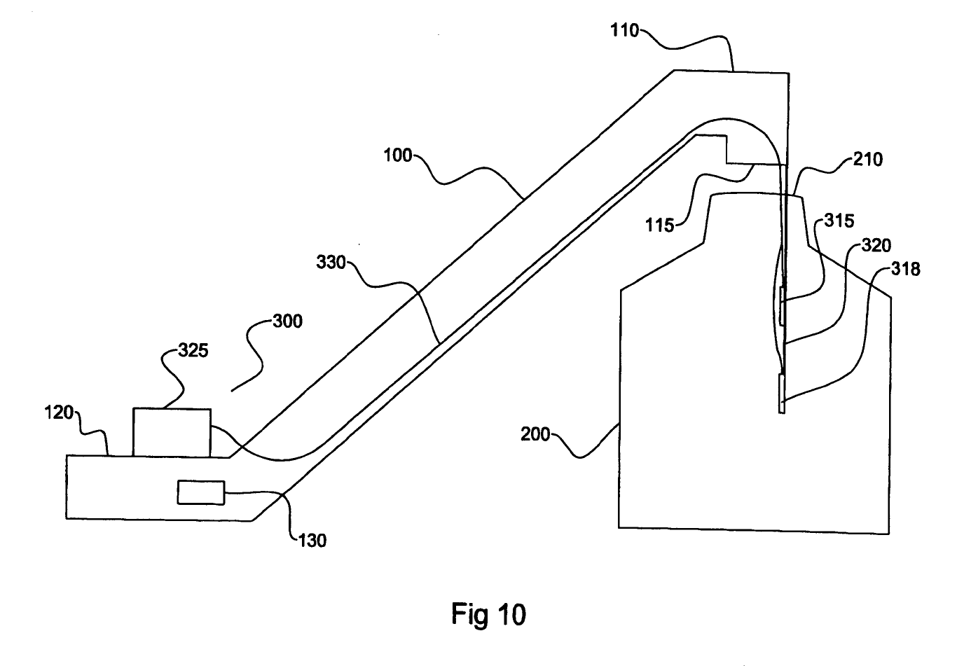

FIG. 10 is a side view of the bin fill indicator apparatus of FIG. 7 installed on an auger.

### DETAILED DESCRIPTION OF THE ILLUSTRATED EMBODIMENTS

FIG. 1 illustrates a bin fill indicator apparatus in accordance with an embodiment of the present invention. Bin fill indicator apparatus 10 comprises: a sensor 15, an attachment tether 20; connecting wires 30 and a monitor 25.

The sensor 15 is a flow sensor as is known in the prior art that is operable to generate a sensor signal in response to sensing the flow of particulate matter past the sensor 15. Generally, although not necessarily, the sensor 15 would be an impact-type sensor and operative to generate a sensor signal in response to the impact of particulate matter against the sensor 15, indicating that the particulate matter is flowing past the sensor 15. Alternatively, the sensor 15 could comprise a light beam and the sensor 15 is operative to generate sensor signals when particulate matter flowing past the sensor 15 is temporarily disrupting the light beam and the sensor 15 stops generating signals when the light beam is constantly disrupted for a period of time. In yet another embodiment of the invention, the sensor 15 could be an ultrasonic-type sensor. An ultrasonic-type sensor uses sound waves to detect objects in proximity to the sensor. Using an ultrasonic-type sensor, the sensor 15 would be operative to generate sensor signals when particulate matter is flowing past the sensor 15 by the use of sound waves to detect the flow of the particulate matter and to stop generating sensor signals when the particulate matter has buried the sensor 15.

The tether 20 is operative to attach the sensor 15 to a discharge end of an auger so that the sensor 15 is positioned beneath a spout on the discharge end of the auger.

The monitor 25, shown in more detail in FIG. 2, comprises a power switch 30, to turn the bin fill indicator apparatus 10 on and off and a corresponding power indicator light 31 to indicate when the power has been turned on. The monitor 25 comprises a sound switch 32 for turning the audible alerts on and off and a corresponding sound indicator light 33 for indicating whether the audible alarms are turned on or off. The monitor 25 comprises an alarm light 34 and a sensor signal light 36. The alarm light 34 lights up to provide a notification to an operator that the monitor 25 has not received a sensor signal from the sensor 15 for a predetermined period of time and the sensor signal light 36 will flash when the monitor 25 receives a sensor signal from the sensor 15.

The monitor 25 has a removable lid 38 which is typically secured to the monitor 25 with the use of screws 42. FIG. 3 illustrates the monitor 25 with the removable lid 38 removed and a number of contact terminals 40 visible. When the monitor 25 provides a notification that the monitor 25 has not received a sensor signal from the sensor 15 for a predetermined period of time, the monitor 25 can send a voltage to contact terminals 40. A device operative to be powered by the contact terminals 40 can be connected to the contact terminals 40 and powered to provide the notification. FIG. 3 illustrates a siren 37 connected to one of the pairs of contact terminals 40. When the monitor 25 provides a notification that a sensor signal has not been received from the sensor 15 for a predetermined period of time, the monitor 25 provides a voltage to the contact terminals 40 causing the siren 37 to sound an audible alarm. Although a siren 37 is illustrated in

FIG. 3, a person skilled in the art will understand that any number of electrical devices could be connected to the contact terminals 40, to be activated when the monitor 25 has not received a sensor signal from the sensor 15 for a predetermined period of time, such as lights or as an electrical control signal to operate another apparatus such as being used to signal an automatic end gate closer to close an end gate.

The sensor 15 and the monitor 25 are connected by connecting wires 30. FIG. 4 illustrates the wires comprising the connecting wires 30. Connecting wires 30 comprise: a power supply wire 31; a ground wire 32; and a signal wire 33. The power supply wire 31 supplies the power to the sensor 15 (typically 12 volts). The ground wire 32 provides a ground to the circuit. The signal wire 33 is operative to transmit sensor signals from the sensor 15 to the monitor 25 and a constant voltage from the sensor 15 to the monitor 25.

FIG. 5 illustrates the bin fill indicator apparatus 10 installed on an auger 100. The auger 100 has a discharge end 110 with a spout 115 and a bottom end 120. Particulate matter, such as grain or other crop material, or even gravel, is fed into the auger 100 at the bottom end 120. The auger 100 then moves this particulate matter up the auger 100 to the discharge end 110 of the auger 100, where the particulate matter is then discharged out of the auger 100 through the spout 115. A control panel 130 is typically located in proximity to the bottom end 120 of the auger 100. The control panel 130 allows a person to operate the auger 100.

Although this description refers to an auger, someone skilled in the art will appreciate that any type of particulate matter moving apparatus, with a discharge end, used for filling a bin or other container, could be substituted in place of the auger 100. For example, a belt conveyor or a grain vacuum system with a discharge end could be used, with suitable modifications, in place of an auger.

The bin fill indicator apparatus 10 is attached to the auger 100. The sensor 15 is positioned beneath the spout 115 on the discharge end 110 of the auger 100 by attaching an end of the tether 20 to the discharge end 110 of the auger 100 and the sensor 15 to the tether 20, so that the sensor 15 is positioned beneath the spout 115 of the auger 100. The distance the sensor 15 is attached to the tether 20 below the spout 115 of the auger 110 will correspond to a predetermined height that the bin fill indicator apparatus 10 will detect. Moving the sensor 15 higher or lower on the tether 20 sets the height of the particulate matter in the bin 200 that will trigger a notification.

FIG. 6 illustrates an alternative mounting of the sensor 15 and tether 20 of the bin fill indicator apparatus 10. In this alternative mounting of the sensor 15 and the tether 20, the sensor 15 is attached to the tether 20 near the middle of the tether 20. Each end of the tether 20 is then attached to either side of the spout 115 on the discharge end 110 of the auger 100. In this manner, the sensor 15 and tether 20 may be more easily lowered into a bin 200.

Referring again to FIG. 5, the connecting wire 30 is run between the monitor 25 and the sensor 15. Typically, the monitor 25 would be installed on the auger 100 in proximity to the bottom end 120 of the auger 100 near the control panel 130 so that a person operating the auger using the control panel 130 can easily see and operate the monitor 25.

To fill a bin 200 with particulate matter using the auger 100, the auger 100 is positioned so that the spout 115 on the discharge end 110 of the auger 100 is positioned over a fill opening 210 in the bin 200. Particulate matter is then fed into the bottom end 120 of the auger 100 and the auger 100 moves the particulate matter from the bottom end 120 of the auger 100 to the discharge end 110 of the auger 100 where the particulate matter is then discharged out of the auger 100 through the spout 115. With the spout 115 positioned over the fill opening 210 of the bin 200, the particulate matter exiting the spout 115 will flow through the fill opening 210 and into the bin 200. With the sensor 15 positioned beneath the spout 115 of the auger 100, if particulate matter is being discharged out of the spout 115 of the auger 100, the sensor 15 will generate sensor signals in response to the particulate matter flowing past the sensor 15. If the sensor 15 is an impact-type sensor, the sensor 15 is positioned in the path of flow of the discharged particulate matter and as the particulate matter is discharged out of the spout 115 of the auger 100, some of the particulate matter flowing out of the spout 115 of the auger 100 will strike or impact the sensor 15. The sensor 15 will then generate a sensor signal in response to the impact of the particulate matter on the sensor 15.

The bin fill indicator apparatus 10 operates as follows. Before particulate matter is fed into the bottom end 120 of the auger 100, there will be no particulate matter being discharged from the discharge end 110 of the auger 100 and therefore no particulate matter flowing past the sensor 15. After particulate matter has begun to be fed into the bottom end 120 of the auger 100 and is exiting the spout 115 of the auger 100 and into the bin 200, the particulate matter will flow past the sensor 15. As the particulate matter flows past the sensor 15, the sensor 15 will generate sensor signals in response to the particulate matter flowing past the sensor 15. If the sensor 15 is an impact-type flow sensor, the sensor 15 will be positioned within the path of flow of the particulate matter exiting the spout 115 of the auger 100 and when particulate matter impacts the sensor 15, the sensor 15 will generate sensor signals in response to these impacts. Typically, the sensor signals will be a 0 volt pulse.

Before the auger 100 is started and no particulate matter is being discharged out the spout 115 of the auger 100 to flow past the sensor 15, the monitor 25 does not receive any sensor signals from the sensor 15. Because the monitor 25 is not receiving any sensor signals from the sensor 15, after the monitor 25 has been turned on for a predetermined time and the monitor 25 has not received any sensor signals, the bin fill indicator apparatus 10 enters into an alarm state and the monitor 25 provides a notification to the operator. This notification can be the lighting of the alarm light 34, the sounding of an audible alarm, supplying a voltage to the contact terminals 40 or all three. This notification tells the operator that the bin fill indicator apparatus 10 is operating normally. At this point the operator does not expect sensor signals to be sent by the sensor 15 to the monitor 25 because the operator has not yet started the auger 100 and particulate matter will not be flowing past the sensor 15. If the monitor 25 does not provide the notification to the operator, the operator will know that something is not operating properly with the bin fill indicator apparatus 10 because the notification should be provided.

Conveniently, when the bin fill indicator apparatus 10 is installed and turned on, the sensor 15 will send a constant voltage over the connecting wires 30 to the monitor 25. Typically this constant voltage is 5 volts. When the monitor 25 receives this constant voltage and is not receiving any sensor signals, the monitor 25 will go into the alarm state and provide a notification to the operator as described above. Because the operator has not yet started the auger 100, this notification will tell the operator of the auger 100, that the sensor 15 is receiving power and the connecting wires 30 are forming a circuit between the sensor 15 and the monitor 25. If the sensor 15 is not functioning properly, such as when there is a problem with the connecting wires 30 causing an open circuit in the wiring between the monitor 25 and the sensor 15 or the sensor 15 is unable to send signals to the monitor 25, the monitor 25 does not detect this constant voltage from the sensor 15. Rather, the monitor 25 detects 0 volts from the sensor 15 for an extended period of time and the monitor 25 provides an error notification to the operator of the auger 100. Typically, this error notification comprises blinking all of the lights on the monitor 25 including: the power indicator light 31; sound indicator light 33; the alarm light 34; and the sensor signal light 36 and sounding an audible alarm. If an audible alarm is sounded, the audible alarm acting as the error notification typically is a noticeably different pitch than an audible alarm used as a notification that no sensor signals are being received by the monitor 25. This error notification will alert the operator that the bin fill indicator apparatus 10 is not functioning properly, before the operator begins to fill the bin 200 with particulate matter using the auger 100.

When the operator starts filling the bin 200 with particulate matter using the auger 100 and the monitor 25 receives the first sensor signal generated by the sensor 15, the bin fill indicator apparatus 10 leaves the alarm state and the monitor 25 stops providing the notification to the operator. In this manner, should the operator start filling the bin 200 with particulate matter and the bin fill indicator apparatus 10 does not leave the alarm state and the monitor 25 does not stop providing the notification that no sensor signals are being received by the monitor 25, the operator knows that the bin fill indicator 10 is not working properly and the operator can stop filling the bin 200 with particulate matter.

If the bin fill indicator system 10 leaves the alarm state, as the auger 100 continues to fill the bin 200 with the particulate matter, particulate matter continues to flow past the sensor 15 and the sensor 15 continues to generate sensor signals, in response to this flow of particulate matter past the sensor 15 and the sensor 15 transmits these sensor signals to the monitor 25. As long as the monitor 25 receives sensor signals from the sensor 15 within a predetermined period of time, the bin fill indicator apparatus 10 remains out of the alarm state. Eventually, the particulate matter reaches a height in the bin 200 where the sensor 15, hanging from the tether 20, is covered completely with particulate matter. Once the sensor 15 is completely covered by the particulate matter, the particulate matter no longer flows past the sensor 15. If an impact-type flow sensor is used, the sensor 15 is no longer impacted by particulate matter being discharged out of the auger 100. At this point the sensor 15 stops generating sensor signals because it is no longer sensing particulate matter flowing past, the monitor 25 stops receiving sensor signals and the bin fill indicator apparatus 10 once again enters an alarm state and the monitor 25 provides a notification that the monitor 25 is no longer receiving sensor signals from the sensor 15.

Each time the monitor 25 receives a sensor signal from the sensor 15, the monitor 25 activates or “flashes” the sensor signal light 36 to indicate to an operator, of the auger 100, that a sensor signal has been received by the monitor 25. In this manner, if the operator of the auger 100 starts filling the bin 200 with particulate matter, using the auger 100, before the operator has turned on the monitor 25, when the operator switches the monitor 25 on after the auger 100 is already running, the operator will be able to tell that the bin fill indicator apparatus 10 is operating because the sensor signal light 36 is indicating that sensor signals, transmitted by the sensor 15, are being received by the monitor 25.

The monitor 25 provides the notification when it has not received a sensor signal from the sensor 15 for a predetermined period of time, which is typically 3 seconds. When the monitor 25 receives a sensor signal from the sensor 15 the timer is reset and the count begins again. If the predetermined period of time passes and the monitor 25 does not receive another sensor signal, the monitor 25 goes back into an alarm state and provides a notification.

Should anything go wrong with the bin fill indicator apparatus 10, while the auger 100 is filling the bin 200 with particulate matter and the monitor 25 stops receiving sensor signals from the sensor 15, the bin fill indicator apparatus 10 enters the alarm state after the monitor 25 does not receive any sensor signals for the predetermined period of time and the monitor 25 provides a notification to the operator. In this manner, the bin fill indicator apparatus 10 provides a notification to the operator in the event of a failure of the bin fill indicator apparatus 10 during operation. Even if the bin 200 has not been filled to the predetermined height, the operator will believe the bin 200 has been filled and will stop the auger 100. The operator can then inspect the particulate matter in the bin 200 and determine a problem has occurred with the bin fill indicator apparatus 10.

FIG. 7 illustrates another embodiment of a bin fill indicator apparatus 300. The bin fill indicator apparatus 300 comprises a first sensor 315; a second sensor 318; an attachment tether 320; connecting wires 330; and a monitor 325. The bin fill indicator apparatus 300 is similar to the bin fill indicator apparatus illustrated in FIG. 1, with the addition of a second sensor 318.

The first sensor 315 is operative to generate first sensor signals in response to particulate matter flowing past the first sensor 315 and the second sensor 318 is operative to generate second sensor signals in response to particulate matter flowing past the second sensor 318. Generally although not necessarily, the first sensor 315 and the second sensor 318 are impact-type flow sensors and are operative to generate first sensor signals and second sensor signals, respectively, in response to being impacted by particulate matter. The monitor 325 is operative to receive first sensor signals and second sensor signals. Typically, the first sensor signals generated by the first sensor 315 and the second sensor signals generated by the second sensor 318 are transmitted to the monitor 325 through connecting wires 330.

When a predetermined time has elapsed and the monitor 325 has not received a second sensor signal from the second sensor 318, the monitor 325 provides a warning notification. When a predetermined time has elapsed and the monitor 325 has not received a first sensor signal from the first sensor 315, the monitor 325 provides a full notification.

The monitor 325, shown in more detail in FIG. 8, comprises a power switch 330, to turn the bin fill indicator apparatus 300 on and off and a corresponding power indicator light 331 to indicate when the power has been turned on. The monitor 325 comprises a sound switch 332 for turning the audible alerts on and off and a corresponding sound indicator light 333 for indicating whether the audible alarms are turned on or off. The monitor 325 comprises a first alarm light 334, a second alarm light 335, a first sensor signal light 336 and a second sensor signal light 337. The first sensor signal light 336 will flash when the monitor 325 receives a first sensor signal from the first sensor 315 and the second sensor signal light 337 will flash when the monitor receives a second sensor signal from the second sensor 318. The second alarm light 335 lights up to provide a warning notification to an operator that the monitor 325 has not received a second sensor signal from the second sensor 318 for a predetermined period of time and the first alarm light 334 lights up to provide a full notification to an operator that the monitor 325 has not received a first sensor signal from the first sensor 315 for a predetermined period of time.

The first sensor 315, the second sensor 318 and the monitor 325 are connected by connecting wires 330. FIG. 9 illustrates the wires comprising the connecting wires 330. Connecting wires 330 comprise: a power supply wire 381; a ground wire 382; a first signal wire 383 and a second signal wire 384. The power supply wire 381 supplies the power to the first sensor 315 and the second sensor 318 (typically 12 volts). The ground wire 382 provides a ground to the circuit. The first signal wire 383 is operative to transmit first sensor signals from the first sensor 315 to the monitor 325 and a constant voltage from the first sensor 315 to the monitor 325. The second signal wire 384 is operative to transmit second sensor signals from the second sensor 318 to the monitor 325 and a constant voltage from the second sensor 318 to the monitor 325.

FIG. 10 illustrates the bin fill indicator apparatus 300 attached to an auger 100. The second sensor 318 will be positioned below the first sensor 315. As particulate matter fills a bin 200, the particulate matter flows past both the first sensor 315 and the second sensor 318. As the particulate matter flows past the first sensor 315, the first sensor 315 generates first sensor signals in response to this flow of particulate matter. If an impact-type flow sensor is used, as the first sensor 315 is impacted by the particulate matter the first sensor 315 generates first sensor signals in response to each of these impacts and these first sensor signals are received by the monitor 325. As the particulate matter flows past the second sensor 318, the second sensor 318 generates second sensor signals in response to this flow of particulate matter. If an impact-type flow sensor is used, as the second sensor 318 is impacted by the particulate matter, the second sensor 318 generates second sensor signals in response to each of these impacts and these second sensor signals are received by the monitor 325.

As the bin 200 fills with the particulate matter, the second sensor 318 is eventually covered by the particulate matter. At this point, the monitor 325 stops receiving second sensor signals from the second sensor 318 because the second sensor 318 is covered by the particulate matter and the monitor 325 provides a warning notification to the operator. Because the first sensor 315 is positioned above the second sensor 318, the particulate matter will still flow past the first sensor 315 after the second sensor 318 is buried in particulate matter, as long as the first sensor 315 is not buried by particulate matter. The operator then knows that the particulate matter has covered the second sensor 318 and the particulate matter has just about filled the bin 200.

Once the first sensor 315 is also covered by particulate matter, the monitor 325 stops receiving first sensor signals from the first sensor 315 and provides a full notification to the operator. At this point, the operator knows the bin 200 is full.

Typically, the warning notification provided by the monitor 325 when the monitor 325 is not receiving second sensor signals from the second sensor 318 comprises an audible alarm and lighting the second alarm light 335 on the monitor 325. Typically, the full notification provided by the monitor 325 when the monitor 325 is not receiving first sensor signals from the first sensor 315 comprises an audible alarm and lighting the first alarm light 334. Generally, although not necessarily, the audible alarm for the warning notification sounds for a period of time and then ends. Typically, although not necessarily, the audible alarm for the warning notification and the audible alarm for the full notification comprise different sounds so that an operator can aurally distinguish between a warning notification and a full notification.

Although FIGS. 7 and 10 illustrate the use of two sensors, a first sensor 315 and a second sensor 318, it is contemplated to be within the scope of the invention that any practical number of sensors could be used with the bin fill indicator apparatus 300. Additionally, connecting wires 330 could comprise a number of wires allowing the monitor 325, the first sensor 315, the second sensor 318 and any additional sensors to communicate using a digital form of communication, such as the RS-485 standard, which would allow a number of sensors to be connected to the connecting wires 330 without needing to add additional wires for each additional sensor added to the bin fill indicator system 300. This would also allow the addition of other types of sensors that may be useful, such as a moisture sensor, to be added to the bin fill indicator 300 by connecting the sensors to the connecting wires 330.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

We claim:

1. A bin fill indicator apparatus for determining when particulate matter filling a bin has reached a predetermined height, the apparatus comprising:
a sensor attachable beneath a spout on a discharge end of an auger and operative to generate sensor signals in response to particulate matter flowing past the sensor; and
a monitor operatively connected to the sensor and operative to receive sensor signals and operative to provide a notification when the monitor has not received a sensor signal within a predetermined period of time.

2. The apparatus of claim 1 wherein the sensor is an impact-type flow sensor and is operative to generate a sensor signals in response to particulate matter impacting the sensor.

3. The apparatus of claim 1 wherein the sensor generates a constant voltage when no particulate matter is flowing past the sensor and the sensor signal comprises a signal voltage wherein the signal voltage is different from the constant voltage.

4. The apparatus of claim 3 wherein the sensor signal is a voltage of zero volts.

5. The apparatus of any one of claim 1 wherein the monitor is adapted to be installed in proximity to a bottom end of an auger.

6. The apparatus of claim 3 wherein the monitor is operative to provide an error notification when the monitor does not receive a constant voltage from the sensor for a predetermined period of time.

7. The apparatus of claim 1 wherein the monitor comprises a light and the notification comprises activating the light.

8. The apparatus claim 1 wherein the notification is an audible alarm.

9. The apparatus of claim 1 wherein the notification supplies power to a pair of electrical contacts operative to power electrical devices connected to the electrical contacts.

10. The apparatus of claim 1 wherein the monitor comprises a sensor signal light that is activated when the monitor receives a sensor signal from the sensor.

11. The apparatus of claim 1 comprising a first sensor and a second sensor attachable beneath the spout on the discharge end of the auger and operative to generate first sensor signals in response to particulate matter flowing past the first sensor and a second sensor attachable beneath the first sensor and operative to generate second sensor signals in response to particulate matter flowing past the second sensor, the monitor operatively connected to the first sensor and operative to receive first sensor signals and operative to provide a full notification when the monitor has not received a first sensor signal within a predetermined period of time, the monitor operatively connected to the second sensor and operative to receive second sensor signals and operative to provide a warning notification when the monitor has not received a second sensor signal within a predetermined period of time.

12. The apparatus of claim 1 comprising a tether that attached to the sensor and adapted to attach to the discharge end of the auger.

13. An auger operative to determine when a bin being filled with particulate matter by the auger has reached a predetermined height in the bin, the auger comprising:
a bottom end operative to receive particulate matter;
a discharge end having a spout wherein particulate matter fed into the bottom end is moved by the auger from the bottom end to the discharge end, where it is discharged from the auger through the spout;
a sensor attached beneath the spout and operative to generate a sensor signal in response to particulate matter flowing past the sensor; and
a monitor operatively connected to the sensor and operative to receive sensor signals and operative to provide a notification when the monitor has not received a sensor signal from the sensor within a predetermined period of time.

14. The apparatus of claim 13 wherein the sensor is an impact-type flow sensor and is operative to generate a sensor signal in response to particulate matter impacting the sensor.

15. The auger of claim 13 wherein the sensor generates a constant voltage when no particulate matter is flowing past the sensor and the sensor signal is a signal voltage wherein the signal voltage is different from the constant voltage.

16. The auger of claim 13 wherein the sensor signal is a voltage of 0 volts.

17. The auger of claim 13 wherein the monitor is located in proximity to a bottom end of an auger.

18. The auger of claim 15 wherein the monitor is operative to provide an error notification when the monitor does not receive a voltage from the sensor for a predetermined period of time.

19. The auger of claim 13 wherein the monitor comprises a light and the notification comprises activating the light.

20. The auger of claim 13 wherein the notification is an audible alarm.

21. The auger of claim 13 wherein the notification supplies power to a pair of electrical contacts operative to power electrical devices connected to the electrical contacts.

22. The auger of claim 13 wherein the monitor comprises a sensor signal light that is activated when the monitor receives a sensor signal from the sensor.

23. The auger of claim 13 comprising a first sensor and a second sensor attachable beneath the spout on the discharge end of the auger and operative to generate first sensor signals in response to particulate matter flowing past the first sensor and a second sensor attachable beneath the first sensor and operative to generate second sensor signals in response to particulate matter flowing past the second sensor, the monitor operatively connected to the first sensor and operative to receive first sensor signals and operative to provide a full notification when the monitor has not received a first sensor signal within a predetermined period of time, the monitor operatively connected to the second sensor and operative to receive second sensor signals and operative to provide a warning notification when the monitor has not received a second sensor signal within a predetermined period of time.

24. The auger of claim 12 comprising a tether that attaches the sensor to the discharge end of the auger.

25. A method of detecting when particulate matter has reached a predetermined height in a bin, comprising:
positioning a sensor beneath a spout on a discharge end of an auger, the sensor operative to generate a signal when particulate matter flows past the sensor;
positioning the spout over a fill opening of the bin;
using the auger to fill the bin with particulate matter;
monitoring the signals generated by the sensor as the particulate matter impacts the sensor;
activating an alarm when a predetermined time has passed and no signals have been generated by the sensor; and
stopping using the auger to fill the bin with particulate matter.
